(19) United States
(12) Patent Application Publication
(10) Pub. No.: US 2014/0154734 A1
(43) Pub. Date: Jun. 5, 2014

(54) SYSTEM AND METHOD FOR HIGH THROUGHPUT TISSUE SAMPLE EXTRACTION

(71) Applicant: Diversified Biotech, Dedham, MA (US)

(72) Inventor: Shih-Li L. Lo, Chino HIlls, CA (US)

(73) Assignee: Diversified Biotech, Dedham, MA (US)

(21) Appl. No.: 13/900,034

(22) Filed: May 22, 2013

Related U.S. Application Data
(60) Provisional application No. 61/650,309, filed on May 22, 2012.

(51) Int. Cl. G01N 1/28; G01N 1/00

(52) U.S. Cl. CPC G01N 1/28; G01N 1/00
USPC 435/30; 73/864.91

(57) ABSTRACT

Systems, methods, and devices involving tube carriers adapted for compatibility with 96-well format shorten and automate fluid handling during homogenization, extraction, or other processing of biological samples for high throughput analysis.

### BACKGROUND

Systems have been developed for high throughout sample analysis. The 96-well plate is a standard for scientific research. Liquid handling technologies, injection systems, and automated robotic systems are available from companies such as Beckman Coulter®, Agilent Technologies®, Eppendorf®, Integra Biosciences®, Tomtec®, and others, and many of these are adapted to the standard 96-well plate format. However, homogenization systems for biological samples, such as tissues and cells, are not set up to interface with a 96-well plate, or to process or present samples in a format compatible with a standard 96-well plate. For example, a Bead Ruptor 24® can homogenize 24 samples at once, but each sample is homogenized in a separate, individual tube. Currently, the standard procedure to transfer the samples to a 96-well plate after homogenization is a manual process whereby the tubes are transferred or contents pipetted, usually one at a time. Such a process is time consuming, and errors can easily occur due to the tedious nature of the task. Alternatively, if samples are not homogenized, they need to be soaked overnight to ensure completed extraction. While this process can avoid the need for homogenization, it can take days to complete, compared to minutes for a homogenization method. Thus, there remains a need to reduce the manual processing required for homogenization or extraction of samples for analysis in a high throughput process, and to allow for automated transfer of samples to a standard 96-well plate format.

### SUMMARY OF THE INVENTION

The invention provides systems, methods, and devices which shorten tissue sample homogenization, extraction, or similar processing from days to hours, reduce the amount of manual processing required for such operations, and reduces or eliminates the human error that sometimes occurs from manual processing and transfer of samples. In particular, the present invention converts the process of manual homogenization and extraction of tissue samples to a semi-automatic “96-well” format process.

One aspect of the invention is a tube carrier. The tube carrier includes an array of tube receptacles for receiving cylindrical tubes containing liquid samples. The tubes each have a volume of at least 1.5 mL, and the position of each tube receptacle aligns with a corresponding position on a standard 96-well plate. The carrier is fabricated from a high specific heat material to maintain temperature stability of the samples. The tube carrier can accommodate up to 48 tubes while maintaining alignment with 96-well format. In some embodiments, the base of the carrier is suitable to fit within a device such as a centrifuge or a thermal control device. Some embodiments of the carrier also include viewing windows along at least one side of the carrier that permit visualization of contents of each tube and allow adjustment of vertical depth of travel of pipette tips of a liquid handling device. In some embodiments, the tube receptacles of the carrier have a shape that closely conforms to the shape of a selected tube, to provide efficient thermal equilibration between the carrier material and the samples.

Another aspect of the invention is a kit containing a pair of first and second carriers. The first carrier has tube receptacles corresponding in position to a first set of every other well of a 96-well plate, and the second carrier has tube receptacles corresponding in position to a second set of every other well of a 96-well plate. The pair of carriers together have tube receptacles corresponding in position to every well of a 96-well plate. In some embodiments, each carrier of the pair has essentially the same weight, for use as counterbalances to each other during centrifugation.

Yet another aspect of the invention is a high-throughput method of transferring sample liquid from a plurality of tubes having a volume of at least 1.5 mL each to 96-well plates. The method includes the steps of: transferring the tubes into tube receptacles of a tube carrier as described above; removing liquid simultaneously from all of the tubes in the tube carrier using a liquid handling device; and depositing the liquid simultaneously into wells of a 96-well plate using the liquid handling device. Some embodiments of the method further include centrifuging the tubes simultaneously in the carrier. Some embodiments include setting a depth of travel into the tubes of pipet tips of a liquid handling device using the viewing windows prior to removing liquid with the liquid handling device. In some embodiments, the temperature of the carrier is controlled using a temperature control device. In certain embodiments, the method is carried out using the pair of first and second carriers described above, and samples from the tubes of the first and second carrier are combined into a single 96-well plate using a fluid handling device.

### BRIEF DESCRIPTION OF THE DRAWINGS

FIG. 1 is a top view of a first carrier of the invention, with one possible numbering system for 2 mL tubes. Different numbering systems can be used which, for example, depend upon the number of tubes and/or the downstream sample processing and analysis.

FIG. 2 is a top view of a second carrier of the invention, with one possible numbering system for 2 mL tubes. Different numbering systems might be used depend upon the number of tubes and/or the downstream sample processing and analysis.

FIG. 3 is a top view of an embodiment of a first carrier of the invention, showing dimensions in inches and the numbering system of FIG. 1.

FIG. 4 is a top view of an embodiment of a second carrier of the invention, showing dimensions in inches and the numbering system of FIG. 2.

FIG. 5 is a side view of the embodiment shown in FIG. 1 with 2 mL tubes in positions 1, 3, 5, 7, 9 and 11 as shown in FIG. 1.

FIG. 6 is a top view of the embodiment shown in FIG. 1 with 2 mL tubes in positions 1, 3, 5, 7, 9 and 11 as shown in FIG. 1.

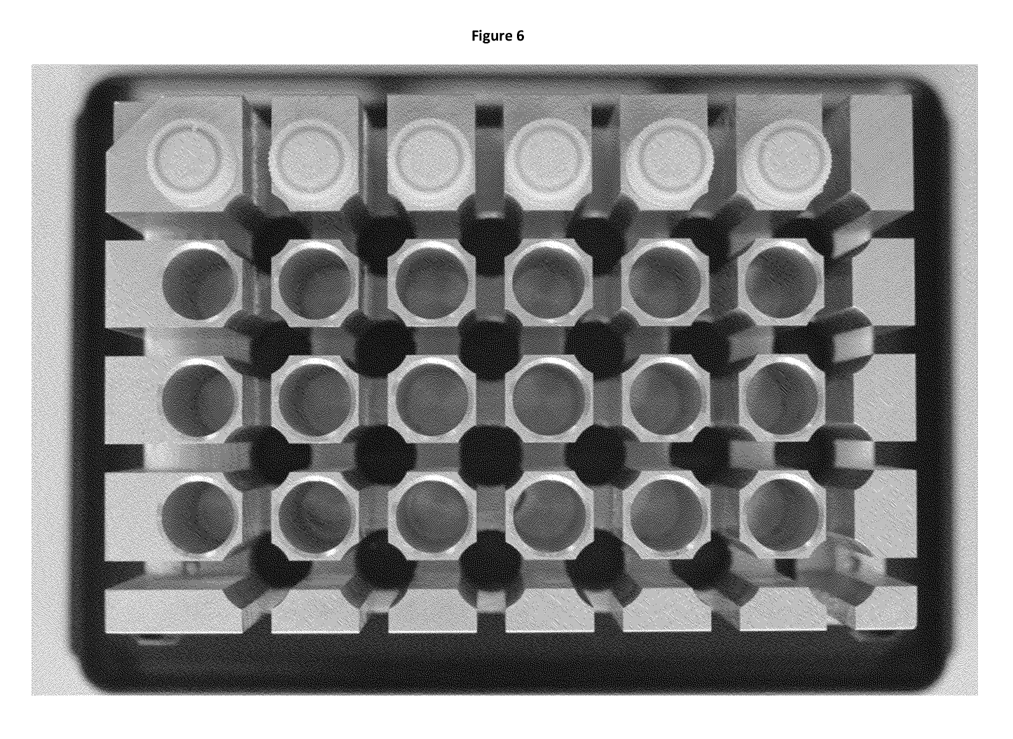

### DETAILED DESCRIPTION OF THE INVENTION

The present invention provides a solution to the problem of interfacing between fluid samples too large to fit into the standard 96-well plate format and the 96-well plate itself in a high throughput fluid transfer and/or analysis environment. Many types of tubes or vials are used to prepare samples in the 1-2 mL or larger volume range. For example, samples can be extracted, homogenized, centrifuged, incubated, treated with enzymes or other reagents, and subsequently it can be desirable to remove an aliquot of such samples and transfer it into a 96-well plate for analysis. Normally, such tubes are too large to fit into the geometry and dimensions of standard 96-well plates. Using one or more tube carriers of the present invention, automated transfer between 96-well microtiter plates and larger tube formats is possible. This fluid handling interface system can be useful for any type of liquid handling, but is especially useful for the homogenization and/or extraction of biological samples, including tissue samples, cells, and body fluid samples. For example, the tube carriers of the invention can serve as an interface between individual 2 mL extraction vials for the Omni Bead Ruptor® Homogenizer, MP Fast Prep®, or Precellys® and a 96-well plate format.

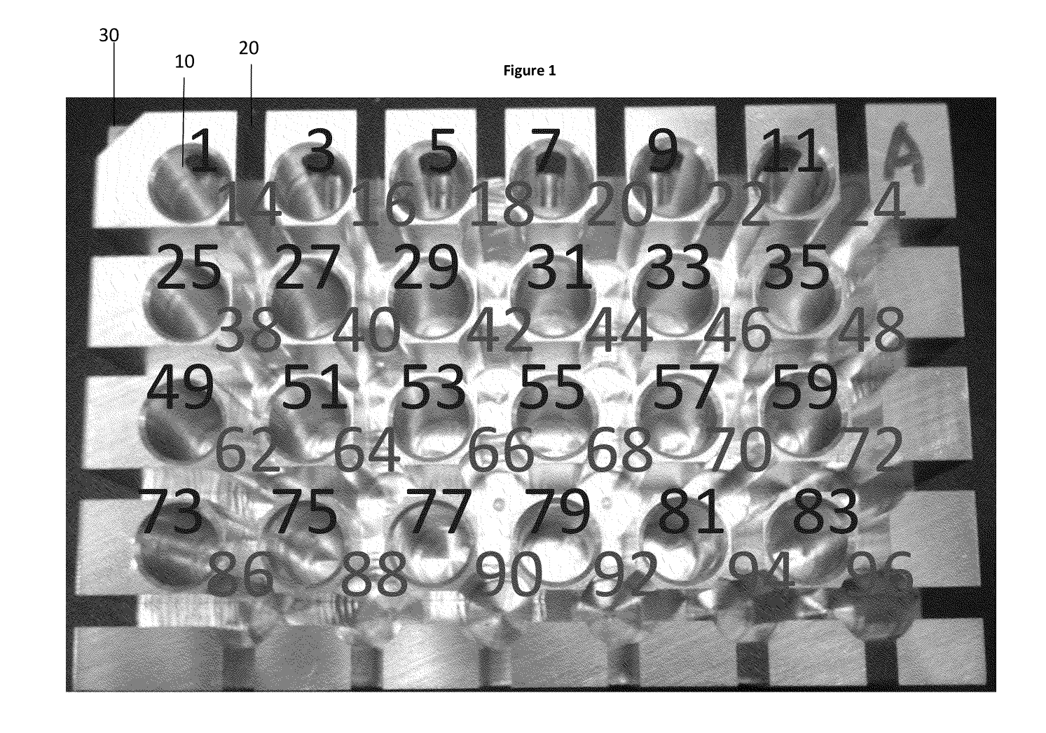

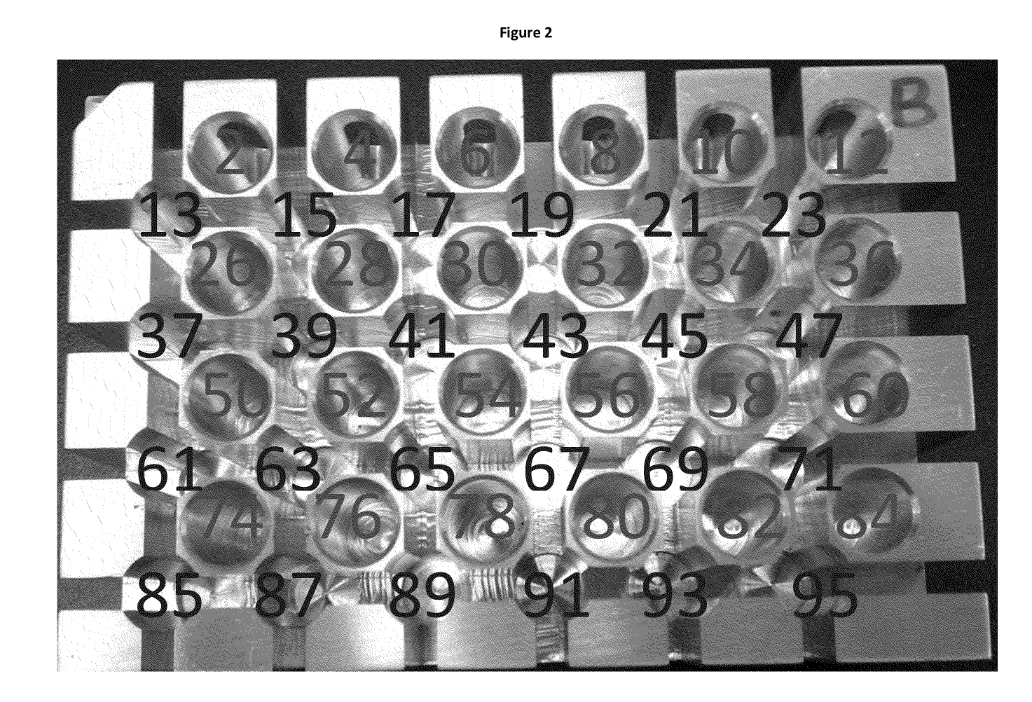

The invention provides a kit containing a pair of first and second carriers. The two carriers of the pair possess suitable dimensions and shape to serve as complementary sample tube carriers which together allow transfer via automated fluid handling equipment of sample fluid from up to 96 tubes in the two carriers combined to up to all 96 wells of a single 96-well plate. Each carrier of the pair provides positions for up to 48 individual sample tubes of specific dimensions (for example, 2 mL tubes, up to 0.4″ in diameter and at least 1.41″ in height), and the positions of the tubes in each carrier are compatible with standard 96-well plate format. That is, each of the up to 48 tube positions of a carrier corresponds to (i.e., aligns with in two dimensions) a well of a standard 96-well plate. The carriers are designed such that each tube fits into a tube receptacle (see FIG. 1, reference numeral 10) in the carrier, and the position of the tube receptacle corresponds to the position of a single, unique well of a 96-well plate. Preferably, the center of each tube receptacle aligns with the center of a well of a 96-well plate. For example, a first carrier can hold 48 tubes or vials in specific positions corresponding to every other well (i.e., 48 wells) of a 96-well plate, and a second carrier can hold another 48 tubes or vials at specific positions corresponding to the remaining 48 wells of a 96-well plate. One embodiment of such a pair of complementary pair of carriers is shown in FIGS. 1 and 2. By placing up to 96 individual sample tubes in the two carriers, automated liquid handling systems can be used to transfer liquid from each sample into a single 96-well plate.

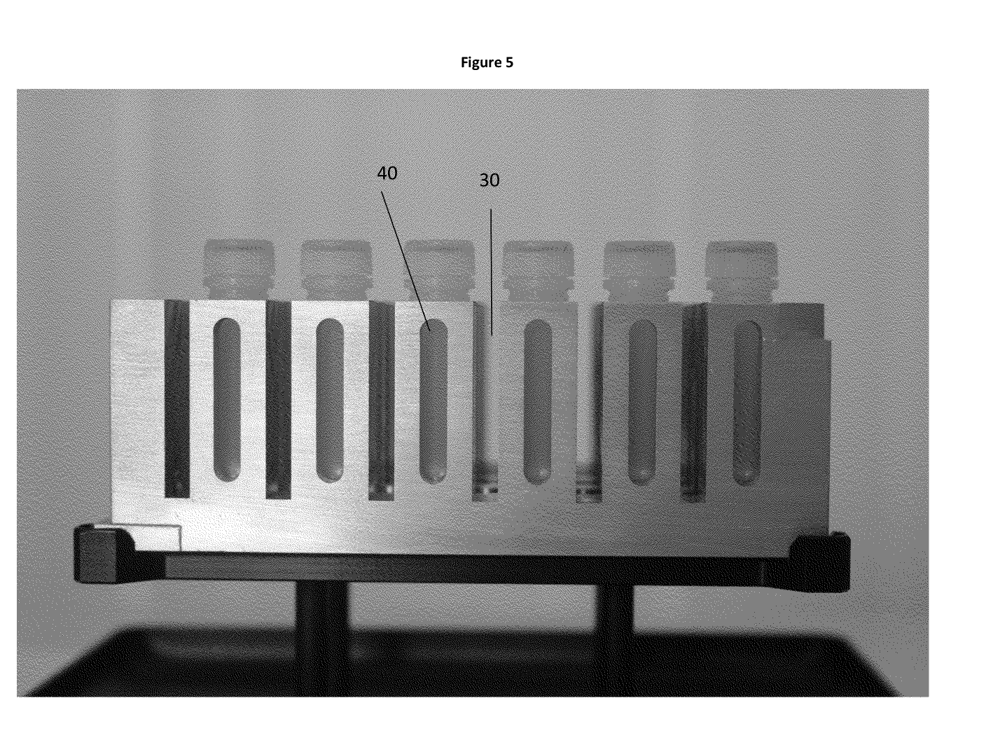

Thus, with a carrier or pair of carriers of the present invention, tubes containing larger volumes than would normally fit in 96-well plate format can be aligned with 96-well plate format and can be accessed by standard liquid handling devices, such as pipetting devices, designed for 96-well format. Tubes for use with the carriers preferably contain a volume of at least 1.5 mL, at least 1.6 mL, at least 1.7 mL, at least 1.8 mL, at least 1.9 mL, at least 2.0 mL, or at least 2.5 mL. The tubes are typically constructed of plastic and are disposable, but also may be constructed of glass or another material. The tubes may be capped or uncapped and preferably are cylindrical in shape, but optionally can have a conical lower portion. Preferably, the tube receptacle closely fits the profile of a selected tube type. The side walls of the carrier can be crenellated as shown in FIG. 1. Using a crenellated structure with crenellation gaps 20 as shown in FIG. 1 provides a visualization pathway to those rows or columns of tubes not visible through visualization windows 40 as shown in FIG. 5.

When dealing with a large number of samples in a high throughput processing environment, the present invention dramatically reduces tissue sample extraction time from days to minutes through semi-automatic transfer of homogenized samples or extracts from individual tubes to a 96-well plate for further processing or analysis. After samples are transferred into a 96-well plate, the remainder of an extraction or analysis protocol can be automated with available 96-well plate technology.

In an embodiment of the present invention, the carrier or pair of carriers is made from a metal or polymer material, or similar durable material. Preferred materials are those with a high specific heat that provides temperature stability during sample transfer or processing. For example, a carrier of the invention maintains a low temperature such as about 4° C., or 0-4° C. during processing, to maintain sample stability by reducing the activity of proteases and nucleases. Metal carriers preferably contain or consist of any rust-resistant metal or alloy thereof such as aluminum, an aluminum alloy, stainless steel, or another rust-free metal alloy. Certain polymer materials including plastics and/or composite materials such as carbon fiber composites may be used in conjunction with a high specific heat material such as water or other liquid solution that fills hollow spaces (see, e.g., FIG. 1) around the tubes positioned in the carrier. A metal carrier or other high specific heat carrier can be pre-chilled before placing tissue samples into the carrier. In this manner, samples can be more easily maintained at a low temperature. One advantage of a lower temperature is to improve stability and/or to allow frozen tissue samples to be pulverized into a powder before adding an extraction solution or solvent. The use of metal also makes possible other temperature control procedures, such as incubation in a thermal regulation device, such as for application of heat treatment, etc.

In an embodiment of the present invention, viewing windows 40 and/or crenellated gaps 20 on at least one side of carriers (see FIG. 5) allow for adjusting the depth of pipette tips for 96-well format automated pipetting devices, to ensure that the positions of the tips are correct for sample transfer. The viewing windows are preferably cut into the sidewall of each tube position along one or more sides of the carrier, and extend vertically from at least the mid-height of the tube to the bottom or near the bottom of the tube, to allow visualization and adjustment of pipette tip position down to the bottom of the tube. Generally, providing viewing windows for each tube along one side of the carrier will be sufficient to permit pipette tip depth of travel adjustment.

In another embodiment of the present invention, the two carriers of a matched pair are essentially equal in weight, so that they can be centrifuged opposite each other at the same time, which eliminates a balancing step and shortens the processing time. Furthermore, in certain embodiments, the footprint of a carrier of the invention (i.e., the dimensions and shape of the bottom or base portion of the carrier) conforms to the footprint of one or more devices that are expected to accept the carrier during processing. Such devices include liquid handling devices, incubators, and centrifuges, which often accept standard 96-well plates dimensions; thus, in certain embodiments the footprint of the carrier (i.e., shape and dimensions of the base) matches the footprint of a standard 96-well plate.

Yet other embodiments of the invention are systems including one or more tube carriers of the invention together with instruments or devices that can accommodate the tube carriers. For example, a system can include one or more tube carriers, or complementary pairs of tube carriers, together with an apparatus for fluid handling, pipetting, manipulation of 96-well plates, thermal regulation, tissue homogenization, or centrifugation.

### EXAMPLES

### Example 1

### Configuration and Construction of a Matched Pair of Carriers

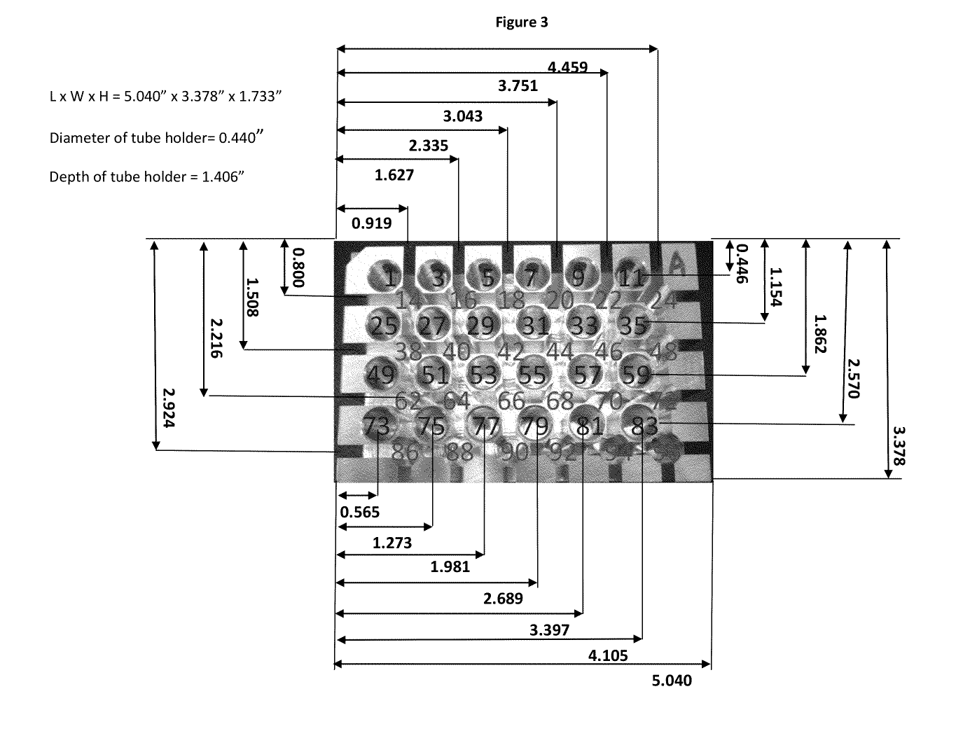

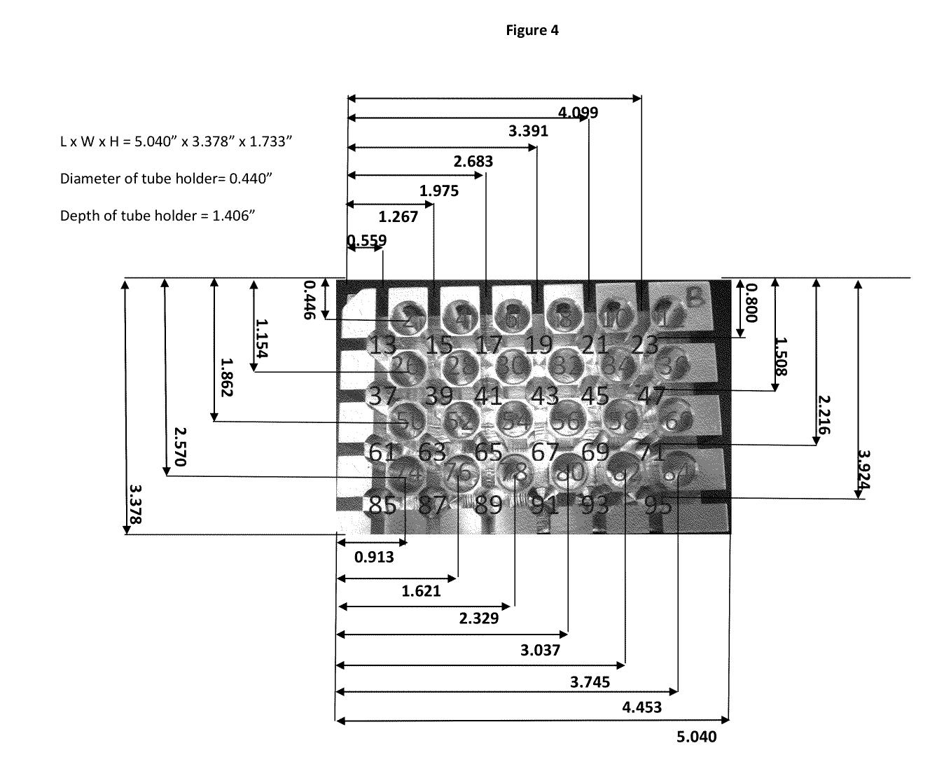

A matched pair of carriers was manufactured by Connelly Machine® in Santa Ana, Calif. following instructions provided by the inventor. Two equal weight aluminum blocks were used as starting material. The outer dimensions of length, width, and height for the finished carriers were both 5.040″×3.378″×1.733″, as shown in FIGS. 3 and 4. Each tube holder was generated by drilling a hole of 0.440″ in diameter and 1.406″ in depth. The location of every tube holder of each carrier is shown in FIGS. 3 and 4. A 0.1″ diagonal cutout (see FIG. 1, reference numeral 30) at the upper left corner was made to aid in identifying the orientation of each carrier. Viewing windows were added by drilling oval-shaped holes, as shown in FIG. 5.

### Example 2

### Use of a Matched Pair of Carriers for High-Throughput Extraction of Rabbit Iris-Ciliary Body

Carriers A and B were pre-chilled at 4° C. 280 rabbit iris-ciliary body (ICB) samples were each extracted with 1 mL of methanol/water (1/1) in 2 mL tubes using an Omni Bead Ruptor 24® at 4° C. under 6.8 meter/sec for 44 seconds. Twenty-four ICB sample tubes were placed in an Omni Bead Ruptor 24 plate and homogenized at the same time. After the first 24 ICB samples were homogenized and removed from the homogenizer, the next set of 24 ICB sample tubes was loaded and homogenized. While the second set of samples was homogenizing, the first set of 24 ICB sample tubes was placed into carriers A and B according to the numbering as set forth in FIGS. 1 to 4. Two more sets of ICB samples were homogenized and transferred to carriers A and B, bringing the total number to 96. Carriers A and B were centrifuged at 4000 rpm for 5 minutes. There was no need for balancing the carriers since both carriers were essentially the same weight, due to the numbering system of the carriers and processing of the sample tubes. Carriers A and B were put into a Tomtec Quadra 4 Handling Workstations® which transferred 300 μL of supernatant from each tube of carriers A and B to a single well of a clean 96-well plate. The viewing windows and/or crenellated gaps on the side of carriers, as shown in FIG. 5, were used to adjust the depth of the Tomtec pipette tips to ensure accurate supernatant transfer. An additional 300 μL of supernatant was transferred to a second 96-well plate. The first 96-well plate samples were subjected to liquid-liquid extraction using methyl tert-butyl ether (MTBE), while the second 96-well plate samples were stored at −20° C. for re-analysis or sample dilution later.

The entire ICB sample homogenization and extraction process was completed within 4 hours. Without using carriers of the present invention, each homogenized sample would have been manually transferred into a 96-well plate. Without the carriers, the step of transferring 280 samples alone required at least 4 hours, and additional time often was lost due to human errors.

### Example 3

### Use of a Matched Pair of Carriers for High-Throughput Extraction of Skin Samples

Carriers A and B as shown in FIGS. 1-4 were pre-chilled at 4° C. before loading homogenized samples. Twenty-four dermatomed ex vivo human cadaver trunk skin samples were each homogenized with 1 mL of methanol in 2 mL tubes using an Omni Bead Ruptor 24 at 4° C. under 6.8 meter/sec for 44 seconds. The 24 sample tubes were placed in an Omni Bead Ruptor 24 plate and homogenized at one time. After sample homogenization, the 24 tubes were removed them from the homogenizer and then placed into carriers A and B (12 tubes in each carrier) according to the numbering of FIGS. 1 and 2. Carriers A and B then were centrifuged opposite each other at 4000 rpm for 5 minutes without balancing. Carriers A and B then were placed into Tomtec Quadra 4 Handling Workstations, and 50 μL of supernatant were transferred from each tube of carriers A and B to a clean 96-well plate. The viewing windows and/or crenellated gaps on the side of the carriers, as shown in FIG. 5, were used to adjust the depth of Tomtec pipette tips to ensure the accurate supernatant transfer. An additional 300 μL of supernatant from each tube was transferred to a second 96-well plate. The first 96-well plate samples were subjected to 120-fold dilution. The second 96-well plate samples were stored at −20° C. for re-analysis. The dermatomed ex vivo human cadaver trunk skin samples were homogenized and extracted within 1 hour.

As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

This application claims the priority of U.S. Provisional Application No. 61/650,309, filed 22 May 2012, and entitled “System and Method for High Throughput Sample Extraction”, the whole of which is hereby incorporated by reference.

What is claimed is:

1. A tube carrier comprising an array of tube receptacles for receiving cylindrical tubes containing liquid samples, the tubes having a volume of at least 1.5 mL each, and the position of each tube receptacle aligning with a corresponding position on a 96-well plate.

2. The tube carrier of claim 1 that is fabricated from a metal or polymer material

3. The tube carrier of claim 2 that is fabricated from a metal, wherein the metal comprises aluminum or an aluminum alloy.

4. The tube carrier of claim 1 comprising 48 of said tube receptacles.

5. The tube carrier of claim 1 comprising a base of suitable dimensions to fit into a centrifuge or a thermal control device.

6. The tube carrier of claim 1 having a two-dimensional arrangement of tube receptacles as shown in FIG. 3 or FIG. 4.

7. The tube carrier of claim 1 having dimensions of tube diameter and tube height and having tube receptacle positions as shown in FIG. 3 or FIG. 4.

8. The tube carrier of claim 1, comprising a plurality of viewing windows along at least one side that permit visualization of contents of each tube adjacent to said side of the carrier.

9. The tube carrier of claim 1, wherein the tube receptacles closely conform to the shape of a predetermined tube type.

10. The tube carrier of claim 1 adapted for use with tubes of a biological tissue homogenization device.

11. The tube carrier of claim 1, wherein the tube receptacles are positioned for compatibility with a liquid handling device for 96-well plates.

12. A kit comprising a pair of first and second carriers according to claim 1, wherein the first carrier has tube receptacles corresponding in position to a first set of every other well of a 96-well plate, the second carrier has tube receptacles corresponding in position to a second set of every other well of a 96-well plate, and the pair of carriers together have tube receptacles corresponding in position to every well of a 96-well plate.

13. The kit of claim 12, wherein one carrier of the pair has an arrangement of tube receptacles corresponding to that shown in FIG. 3, and the other carrier of the pair has an arrangement of tube receptacles corresponding to that shown in FIG. 4.

14. The kit of claim 12, wherein one carrier of the pair has dimensions of tube diameter and tube height and tube receptacle positions as shown in FIG. 3, and the other carrier of the pair has dimensions of tube diameter and tube height and tube receptacle positions as shown in FIG. 4.

15. A high-throughput method of transferring sample liquid from a plurality of tubes having a volume of at least 1.5 mL each to 96-well plates, the method comprising the steps of:
(a) transferring said tubes into tube receptacles of a tube carrier of claim 1;
(b) removing liquid simultaneously from all of the tubes in the tube carrier using a liquid handling device; and
(c) depositing said liquid simultaneously into wells of a 96-well plate using the liquid handling device.

16. The method of claim 15, wherein steps (a)-(c) are carried out first using a carrier having an arrangement of tube receptacles corresponding to that shown in FIG. 3 and then steps (a)-(c) are repeated using a carrier having an arrangement of tube receptacles corresponding to that shown in FIG. 4, or wherein steps (a)-(c) are carried out first using a carrier having an arrangement of tube receptacles corresponding to that shown in FIG. 4 and then steps (a)-(c) are repeated using a carrier having an arrangement of tube receptacles corresponding to that shown in FIG. 3.

17. The method of claim 15, further comprising the step of:
(a1) centrifuging the tubes simultaneously in said carrier.

18. The method of claim 15, wherein the tube carrier comprises viewing windows along each side that permit visualization of contents of each tube adjacent to an edge of the carrier, the method further comprising the step of:
(a2) setting a depth of travel into the tubes of pipet tips of a liquid handling device using the viewing windows prior to performing step (b) with the liquid handling device.

19. The method of claim 15, further comprising controlling the temperature of the tube carrier using a temperature control device.

20. The method of claim 15, wherein the sample liquid comprises a tissue extract, a body fluid, or cells.
